(19) United States
(12) Patent Application Publication
(10) Pub. No.: US 2019/0378335 A1
(43) Pub. Date: Dec. 12, 2019

(54) VIEWER POSITION COORDINATION IN SIMULATED REALITY

(71) Applicant: KREATAR, LLC, New York, NY (US)

(72) Inventors: Lyron L. BENTOVIM, Demarest, NJ (US); Liron LERMAN, Maplewood, NJ (US)

(21) Appl. No.: 16/436,506

(22) Filed: Jun. 10, 2019

Related U.S. Application Data
(60) Provisional application No. 62/683,963, filed on Jun. 12, 2018.

(51) Int. Cl. G06T 19/00; G06F 3/01; G06F 3/14; G06T 15/20; G06F 3/0481

(52) U.S. Cl. CPC G06T 19/006; G06F 3/011; G06T 2219/024; G06T 15/20; G06F 3/04815; G06F 3/14

(57) ABSTRACT

Systems and methods for representing data in a simulated reality (SR) are described. An example method includes accessing, via a computing device of a coordinated SR system, an asset suitable to display in a SR, and receiving first/second real environment user location data for first/second users, respectively, using the coordinated SR system. The method further includes determining, based on the first/second real environment user location data, first/second relative positions within the SR between the asset and a first representation associated with the first user and a second representation associated with the second user, respectively. The method further includes displaying, on a first display device of the coordinated simulated reality system, the asset and the second representation as part of the simulated reality based on the first relative position and the second relative position, and displaying, on a second display device of the coordinated simulated reality system, the asset and the first representation as part of the simulated reality based on the first relative position and the second relative position.

### CROSS-REFERENCE TO RELATED APPLICATIONS

The present application claims priority to U.S. provisional application No. 62/683,963, filed Jun. 12, 2018, entitled “VIEWER POSITION COORDINATION IN SIMULATED REALITY,” which is hereby incorporated by reference in its entirety.

### FIELD

The present invention relates to systems and methods for representing data in a simulated reality.

### BACKGROUND

In traditional data presentation systems for users at different locations, the users receiving the information are isolated from each other, which makes it difficult to interact with one another and with the data limiting the ability of the user to understand, visualize, assess, and benefit from the shared experience. Other presentation systems lack any coordinated representative capabilities that allows a user to analyze, regroup, or update data in a shared environment. Also, lacking user coordination increases errors in the system as users miss important feedback due to interaction between the users because they don't have the tools to understand how they are each interacting with the data. Therefore, an improved system, graphical display, or user interface for presenting and modifying data is desirable.

### SUMMARY

The present invention relates to systems and methods for providing a coordinated simulated reality (SR) environment shared among multiple users. For example, a SR computing system may provide a coordinated and/or synchronized representation of data between the multiple users. The users may view an object (e.g., assets) or each other within the coordinated SR environment from different perspectives or viewpoints. The SR computing system may use a coordinate system to determine respective locations within the coordinated SR environment to populate respective users and objects. Movement of the users and objects may be tracked, and in response to detected movement, the respective locations may be updated. The coordinated SR environment may include environments that are 3D representations of real or simulated worlds. Examples of SR may include virtual reality (VR), augmented reality (AR), and traditional 3D representations on a 2D display.

An example coordinated simulated reality system may include first and second display devices associated with first and second users, respectively, a non-transitory memory containing computer-readable instructions operable to create a simulated reality, and a processor. The processor may be configured to execute the instructions to access an asset suitable to display in the simulated reality, receive first and second real environment user location data for the first and second users, respectively, and determine a first relative position between the asset and a first representation of the first user in the simulated reality and a second relative position between the asset and a second representation of the second user in the simulated reality first and second real environment user location data. The processor may be further configured to execute the instructions to cause first respective renderings of the asset and the second representation to be provided in a first display on the first display device as part of the simulated reality based on the first and second relative positions, and cause second respective renderings of the asset and the first representation to be to be provided in a second display on the second display device as part of the simulated reality based on the first and second relative positions. In some examples, the simulated reality includes an augmented reality platform for the first user, and the processor may be further configured to execute the instructions to receive information from a real environment input device, and cause a real environment to be rendered in the first and second displays on the first and second display devices along with the asset based on the information received from the real environment input device. In some examples, the example coordinated simulated reality may further include a real environment anchor, and the real environment user location data is based, at least in part, on information from the real environment anchors. In some examples, the first user is associated with the real environment anchor. In some examples, the second user is associated with a second real environment anchor. In some examples, the processor may be further configured to execute the instructions to assign a first location to the first user within the simulated reality and a second location to the second user within the simulated reality, and cause the first representation to be rendered at a location in the second display based on the first and second locations and cause the second representation to be rendered at a location in the first display based on the first and second locations. In some examples, the processor may be further configured to execute the instructions to determine a first location of the first user within the simulated reality based on the first real world environment data and a second location of the second user within the simulated reality based on the second real world environment data, and cause the first representation to be rendered at a location in the second display based on the first and second locations and the second representation to be rendered at a location in the first display based on the first and second locations. In some examples, the processor may be further configured to execute the instructions to cause respective renderings of the asset on a surface within the first and second displays. In some examples, the processor may be further configured to execute the instructions to track a spatial relationship the first and second users, and cause a location of the second user to be updated in the first display and a location of the first user to be updated in the second display based on a change in the spatial relationship the first and second users. In some examples, the asset may be viewed from a first perspective on the first display by the first user and is viewed from a second perspective that is different than the first perspective on the second display by the second user. In some examples, the example coordinated simulated reality system may further include an input device configured to receive information in response to input from the first user, and the processor may be further configured to execute the instructions to implement a change to the simulated reality based on information received from the input device. The change to the simulated reality may include a modification of the asset, an interaction with the second user, or a modification of a viewpoint of one the first or second users in the simulated reality.

An example method may include accessing, via a computing device of a coordinated simulated reality system, an asset suitable to display in a simulated reality, receiving first and second real environment user location data for first and second users, respectively, using the coordinated simulated reality system, determining, based on the first and second real environment user location data, a first relative position within the simulated reality between the asset and a first representation associated with the first user and a second relative position within the simulated reality between the asset and a second representation associated with the second user. The example method may further include displaying, on a first display device of the coordinated simulated reality system, the asset and the second representation as part of the simulated reality based on the first relative position and the second relative position, and displaying, on a second display device of the coordinated simulated reality system, the asset and the first representation as part of the simulated reality based on the first relative position and the second relative position. In some examples, the example method further includes receiving information from a real environment input device, and rendering a real environment in the display on the display device along with the asset based on the information received the real environment input device. In some examples, the example method further includes receiving the first and second real environment user location data based on information from a real environment anchor. In some examples, the example method further includes assigning a first location to the first user within the simulated reality and a second location to the second user within the simulated reality based on user input. The second representation may be displayed at a location in the first display device based on the second location and the first representation may be displayed at a location in the second display device based on the first location and the second location. In some examples, the example method further includes determining a first location of the first user within the simulated reality based on the first real world environment data and a second location of the second user within the simulated reality based on the second real world environment data. The second representation may be displayed at a location in the first display device based on the second location and the first representation may be displayed at a location in the second display device based on the first location and the second location. In some examples, the example method further includes displaying, on a second display device of the coordinated simulated reality system, the asset, the first representation, and the second representation as part of the simulated reality based on the first relative position, the second relative position, and the third relative position. In some examples, at least one of the asset, the first representation, or the second representation is displayed on the second display device from a different perspective than displayed on the display device. In some examples, the example method further includes tracking a spatial relationship between the first and second users, and updating display of the first representation or the second representation on the display device based on a change of the spatial relationship between the first and second users. In some examples, the example method further includes updating display of at least one of the asset, the first representation, or the second representation based on a received user input requesting a change to the simulated reality.

### BRIEF DESCRIPTION OF THE DRAWINGS

FIG. 1A illustrates an example first user environment and hardware for interacting with a coordinated simulated realty environment according to various embodiments described herein;

FIG. 1B illustrates an example second user environment and hardware for interacting with a coordinated simulated realty environment according to various embodiments described herein;

FIG. 2 illustrates an example coordinated simulated realty environment according to various embodiments described herein;

FIG. 3 illustrates a block diagram of a computing device for implementing a coordinated simulated realty environment according to various embodiments described herein; and

FIG. 4 includes an exemplary flowchart of a method to provide a coordinated simulated realty SR environment according to various embodiments described herein.

### DETAILED DESCRIPTION

As discussed in detail below, a simulated reality (SR) computing system provides for a coordinated and/or synchronized representation of data between multiple users. Various embodiments and examples of the system and operation are provided herein.

In providing a data presentation, it is valuable to convey the information or allow the user to interact with the information in an interface that transcends the inherent features of the data in order to improve accessibly, usability, or clarity for the user. For example, an appropriate simulated reality asset can be presented to improve the interactive experience or user understanding of the data underlying the asset. Moreover, this experience can be heightened by doing the same with additional users. When the interaction or presentation of the data is sufficiently improved, the ability of the user to assess, use, modify, or interact with like-minded users interested in the data is also improved.

In various embodiments, the systems, devices, and methods discussed herein provide a platform allowing users to see or experience data in three-dimensional (3D) space or in a 3D simulated space (also referred to herein as 3D space) in a way that may lead to better (more accurate, more impactful) and faster insights than is possible when using traditional systems, such as two-dimensional (2D) data systems. The systems, devices, and methods allow a plurality of users to coordinate or synchronize their interaction or presentation of the data with one another. The 3D space also allows users to present data in a way allowing the intended audience to share the experience and connect with the material, mirroring a real world interaction with the data.

Disclosed are systems, devices, and methods for simulated reality (SR) data representations conversions and SR interfaces. The SR interface platforms are achieved by coordinating multiple user's interaction in a common coordinate system defined by the coordinated SR environment and populating the coordinated SR environment with those assets.

SR systems include environments that are 3D representations of real or simulated worlds. SR systems can be displayed on 2D devices such as a computer screen, mobile device, or other suitable 2D display. SR systems can also be displayed in 3D, such as on a 3D display or hologram. Examples of SR include virtual reality (VR), augmented reality (AR), and traditional 3D representations on a 2D display. SR systems immerse users in environments that are either partially or entirely simulated. In AR environments, users interact with real world information via input sensors on the device, providing a partially simulated environment. In VR environments, the user is at least partially immersed in a 3D simulated world with limited real world objects included. Each type of SR system may have objects that are simulations of (i.e., correspond to) real world items, objects, places, people, or similar entities. The objects or conditions can also provide feedback through haptics, sounds, or other suitable methods.

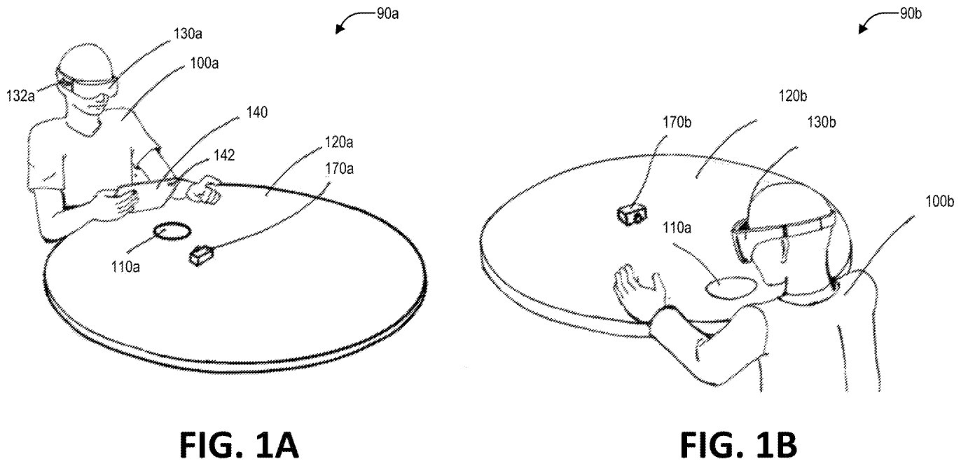

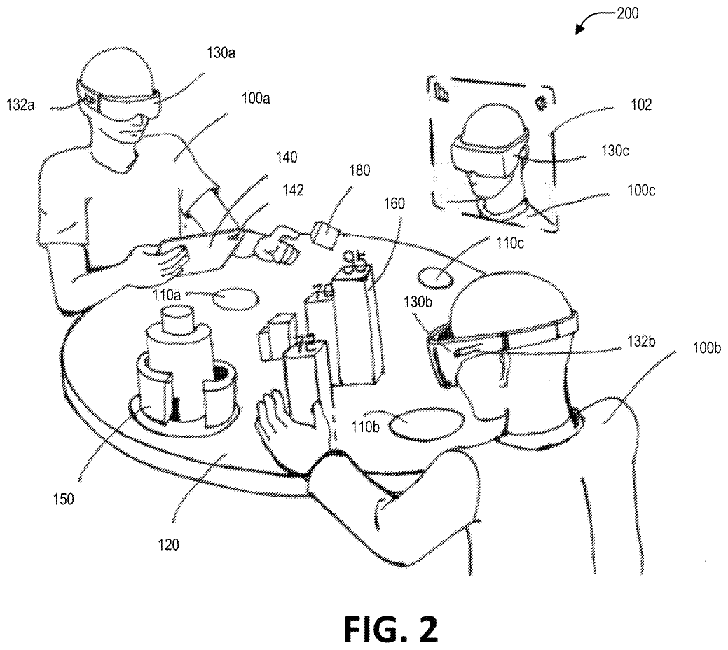

In accordance with various embodiments, the coordinated SR environments discussed herein are configured to share information or data between multiple users. FIGS. 1A and 1B are illustrative of real world user environments and hardware. Specifically, FIG. 1A illustrates an example first user environment 90a and hardware for interacting with a coordinated simulated realty environment according to various embodiments described herein. FIG. 1B illustrates an example second user environment 90b and hardware for interacting with a coordinated simulated realty environment according to various embodiments described herein. FIG. 2 illustrates an example coordinated simulated realty (SR) environment 200 according to various embodiments described herein. FIGS. 1A, 1B, and 2 include common elements. Those common elements have been identified in FIGS. 1A, 1B, and 2 using the same reference numbers. As depicted in FIG. 2, the coordinated SR environment 200 includes various assets that make up the coordinated SR environment 200, including users 100a, 100b, and 100c, and the shared presentation data 150, 160, 180. The shared presentation data 150, 160, 180 may pertain to any set of data to be analyzed, monitored, manipulated, updated, or otherwise handled or shared by the users 100a, 100b, and 100c. The shared presentation data 150, 160, 180 may relate to any suitable information that is or can be stored in a database or similar systems.

In accordance with various embodiments, a coordinated simulated reality system is configured to allow multiple users, e.g., users 100a, 100b, and 100c, to engage in a coordinated interaction together in a common SR environment 200 as shown by way of example in FIG. 2. The coordinated SR system 200 includes one or more environment input devices (e.g., one or more cameras) and one or more display devices (e.g., one or more 2D display devices, 3D display devices, or combinations thereof) suitable to coordinate the position, location, and/or actions of the various users 100a, 100b, and/or 100c. In various embodiments, each of the users 100a, 100b, and/or 100c may be associated with one or more of the display devices 102, 130a-c, 140 and/or one or more of the input devices 132a-b, 142, 170a-b (from FIGS. 1A and 1B, respectively).

For example, referring to FIGS. 1A, 1B, and 2, the input devices can include the cameras 132a, 132b, 142, 170a, or 170b. The cameras 132a, 132b, 142, 170a, or 170b allow for the real environment 90a, 90b to be converted into the simulated reality environment 200, either as a direct image of the real environment 90a or 90b or as a conversion to a virtual environment. In some examples, the cameras 132a, 132b are user-mounted, allowing for a collection of information (e.g., video) of the users' environment. This enables the SR platform configured to provide the coordinated SR environment 200 to collect data related to the users 100a, 100b, 100c real world environment and surroundings, and then recreate and/or display the users 100a, 100b, 100c in the user's respective environment of the coordinated SR environment 200. In some examples, the input devices (e.g., cameras 170a, 170b) are external to the users 100a, 100b, 100c allowing for collection of information related to the users 100a, 100b, 100c directly (e.g., video, motion, gestures, etc.). This enables the SR platform to collect data related to the users 100a, 100b, 100c persons and then recreate the users 100a, 100b, 100c as videos of the users 100a, 100b, 100c or as avatars for display in the user's respective environment of the coordinated SR environment 200.

The display devices 102, 130a-c, 140 can include one or more devices suitable to present the coordinated SR environment 200 to the users 100a, 100b, 100c. The display devices 102, 130a-c, 140 may include one or more of SR goggles 130a-c, 130b, VR headset 130c, handheld devices 140 (e.g., tablet, phone, laptop, etc.), larger devices 102 (e.g., desktop, television, hologram, etc.).

In one example, as illustrated in FIG. 1A, the user 100a can have a real world environment 90a with suitable hardware to operate or interact with the SR platform. This may include one or more displays, such as the SR goggles 130a or the tablet 140, to see the coordinated SR environment 200. The tablet 140 can be used as a control device, as well for interacting with the data, other users, or the coordinated SR environment 200. A separate input device, such as the camera 170a, may be provided to provide spatial, location, movement, or other information related to the user 100a and provide sufficient information for the SR platform to display the user 100a or an aspect of the user 100a in the coordinated SR environment 200 for each of the other users 100b and 100c to experience. In various embodiments, the input device may include multiple input devices. For example, the camera 170a may include multiple optics configured to capture sufficient information to render a three dimensional image of the information received (e.g., the user 100a or the user's surroundings). In some examples, these optics may be closely located to one another as shown with the camera 170a. In other examples, the optics may be located around the room and be able to stitch together a 3D representation of the room or the user 100a. In other embodiments, a 2D representation of the user 100a may be mapped onto a 3D representation. In other embodiments, a 2D representation of the user 100a may be used in the coordinated SR environment 200.

In various examples, as illustrated in FIG. 1B, a second user 100b can have a second real world environment 90b with suitable hardware to operate or interact with the SR platform. This may include one or more displays, such as SR goggles 130b or a tablet similar to the tablet 140 being used by the user 100a to see the coordinated SR environment 200. The tablet can be used as a control device as well for interacting with the data, other users, or the environment. A separate input device, such as the camera 170b, may be provided to provide spatial, location, movement, or other information related to the user 100b and provide sufficient information for the SR platform to display the user 100b or an aspect of the user 100b in the coordinated SR environment 200 for each of the other users 100a and 100c.

In accordance with various embodiments, the SR platform is configured to collect sufficient data from the multiple users 100a, 100b, and 100c and their environments (e.g., 90a and 90b of FIGS. 1A and 1B, respectively for users 100a and 100b) to determine and represent relative positions between the users 100a, 100b, and 100c in the coordinated SR environment 200. In some examples, the relative positions between the users 100a, 100b, and 100c may be assigned (e.g., based on input from a user) within the coordinated SR environment 200. In some embodiments, the various users 100a, 100b, and 100c can engage in activity in their real world environments (e.g., 90a and 90b of FIGS. 1A and 1B, respectively for users 100a and 100b) while that activity is conveyed to the other users 100a, 100b, and 100c on the system and presented as though those activities occur in the coordinated SR environment 200. To accomplish this, the SR platform may be configured to receive input that can track the locations and relative movements of the users 100a, 100b, and 100c or allow the users 100a, 100b, and 100c to move or otherwise operate their avatars (or representations) 131a, 131b, 131c. Other user representations and/or avatar forms may be implemented without departing from the scope of the disclosure.

In accordance with various embodiments, as illustrated in FIG. 2, the coordinated SR environment 200 may also include additional assets created for the sake of interaction within the coordinated SR environment 200. In one example, the asset may be a display of information or data that the various users are seeking to assess, discuss, modify, or otherwise share with one another. The data may be displayed as a direct representation of the underlying information or may be displayed in a representative layout 150, 160, 180 discussed in more detail below. In another example, the asset may be the presentation stage 120. Such an asset may be a recreation of the presentation stage 120a and/or 120b of the real world environments 90a and/or 90b of FIGS. 1A and 1B, respectively, or may be an SR platform-created asset suitable to represent presentation stages for all of the users 100a, 100b, and 100c in the event that the users' various real world environments (e.g., 90a and 90b of FIGS. 1A and 1B, respectively) are substantially different.

In accordance with various embodiments, the users 100a, 100b, 100c may also interact directly with the assets in the coordinated SR environment 200. To accomplish this, the SR platform may be configured to track the locations and movements of the avatars 131a, 131b, 131c relative to the assets (e.g., 120, 150, 160, 180). In one embodiment, the SR platform establishes a coordinate system in which it locates the assets and then tracks the avatars 131a, 131b, 131c of the users 100a, 100b, and 100c relative to the assets (e.g., 120, 150, 160, 180). The movement of the avatars 131a, 131b, 131c may be based on various inputs into the SR platform, but in one particular embodiment, the movement of the avatars 131a, 131b, 131c is generally reflective of the actual movement of the users 100a, 100b, 100c.

Additionally or alternatively, the coordinated SR environment 200 may be formed around one or more real environment anchors (e.g., 110a, 110b, 110c). In one embodiment, a presenter sets out a physical anchor, which correlates to the location of the asset (e.g., data or presentation provided by the user presenting the same). In various embodiments, each user 100a, 100b, and 100c uses or has access to at least one of the one or more real environment anchors (e.g., 110a, 110b, 110c). Each user 100a, 100b, and 100c can have a different real environment anchor (e.g., 110a, 110b, 110c) than the other users. An individual user's 100a, 100b, or 100c respective real environment anchor 110a, 110b, or 110c may correlate to the location of the presentation for the respective user 100a, 100b, or 100c. In one example, the user's 100a, 100b, or 100c respective real environment anchor 110a, 110b, or 110c may include the display location of the asset. In another example, the user's 100a, 100b, or 100c respective real environment anchor 110a, 110b, or 110c may be offset from the display location of the asset. In this example, the presenting user 100a, 100b, or 100c may set the location of the asset with the respective real environment anchor 110a, 110b, or 110c and the other user's 100a, 100b, or 100c respective real environment anchors 110a, 110b, or 110c may set a boundary away from the asset.

In some embodiments, a single user 100a, 100b, or 100c may place one or more anchors that orients one or more of the presentation, the presenter, the viewing users 100a, 100b, or 100c, or the environment around the one or more anchors. In other embodiments, a single user 100a, 100b, or 100c may place multiple anchors with each of the multiple anchors orienting assets in the coordinated SR environment 200, such as location of the presentation, or locations of each of the users 100a, 100b, or 100c being represented in the coordinated SR environment 200.

In some embodiments, the anchors may be utilized to establish the location of the users 100a, 100b, or 100c (and/or the respective representations or avatars 131a, 131b, 131c) relative to the asset and/or to one another. These relative locations may be used to render the respective representations or avatars 131a, 131b, 131c in respective displays viewed by the users 100a, 100b, or 100c. For example, a user's 100a, 100b, or 100c input device may keep track of the relative location of the user 100a, 100b, or 100c to the anchor and this location may be translated into the SR platform for representation in the coordinated SR environment 200. In such an example, the SR platform may be configured determine a simulated reality location of each of the users 100a, 100b, and 100c by determining the real world location of each of the users 100a, 100b, and 100c with respect to the user's 100a, 100b, or 100c respective real environment anchor 110a, 110b, or 110c. It should be appreciated that other location identifying methods may be used as well. In accordance with various embodiments, the SR system (or SR platform) may find user location or user device location in accordance with any of the embodiments disclosed in provisional patent application no. 62/548,762, hereby incorporated by reference in its entirety.

In various examples, the real environment anchors 110a, 110b, 110c may be tangible real world objects. For example, the real world object could be a piece of paper (e.g., business card), an input device, a part of the table/room, or any other suitable physical real world asset that can be picked up by an input device, allowing the SR platform establish a coordinate system or similar spatial recognition parameters. These spatial recognition parameters may allow one or more of the users 100a, 100b, and/or 100c (e.g., the presenter to fix, orientate, or otherwise manipulate the asset for the benefit of the presentation). In some embodiments, the SR platform may be configured to track, update, or display the spatial relationships between each of the users 100a, 100b, and 100c based on each of the users' 100a, 100b, and 100c locations within the common coordinate system. This tracking, updating, or displaying of the locations and positions can also be done with respect to the various displayed assets. This capability enables non-presenting or presenting users 100a, 100b, or 100c to point, touch, or otherwise manipulate the assets such as displayed data. Additionally, this capability allows for different and changing viewpoints for each of the users 100a, 100b, or 100c, which allows the asset to be viewed in different ways. This also allows different users 100a, 100b, or 100c to see how the other users 100a, 100b, or 100c are viewing the asset from different perspectives.

In accordance with various embodiments, the SR platform may include other input devices suitable to communicate with other users. For example, users 100a, 100b, or 100c may be able to talk to one another via the SR platform. In another example, text symbols or other information can be displayed and aligned to each of the user's 100a, 100b, or 100c proper view for communication. The input device can also be used to change the information on which the asset is based. In this way, the input device allows a user 100a, 100b, or 100c to implement a change in the coordinated SR environment 200, while conveying the user's 100a, 100b, or 100c changes to the asset to the other users 100a, 100b, or 100c. Changes to the coordinated SR environment can include a modification of the asset, an interaction with another user 100a, 100b, or 100c, a modification of the viewpoint of one of the user's 100a, 100b, or 100c in the simulated reality or other suitable modifications to the coordinated SR environment 200 improving the sharing of information between users 100a, 100b, and 100c.

As used in the SR platform any of a variety of assets can be displayed that may be based on any of a variety of information that resides in the SR platform or it's otherwise imported into the SR platform. In accordance with various embodiments, the SR system (or SR platform) may be configured to import data or may be configured to receive data entered by one or more of the users 100a, 100b, or 100c into a database or similar collection application, such as a spreadsheet. In accordance with various embodiments, data is represented in an SR format to provide user perspective and visualization of the various attributes of the data amongst multiple users. For example, the entries (e.g., including variables, values, data-points, characteristics, or attributes of the record) may be represented in the representative attributes. In accordance with various embodiments, the SR system (or SR platform) may represent the source data by proxy, directly, or as a combination of proxy and direct representation. Using the example above, the SR system (or SR platform) may show data in traditional graphical form or in other representative forms. In accordance with various embodiments, the SR system (or SR platform) may implement the data in accordance with any of the embodiments disclosed in U.S. patent application Ser. No. 15/887,891,hereby incorporated by reference in its entirety.

In accordance with various embodiments, the coordinated SR environment 200 may include an augmented reality platform for at least one of the users 100a, 100b, or 100c. Thus, the user 100a, 100b, or 100c has a real environment input device and renders the asset in the display device, showing an image of a real environment on the display device along with the asset.

While the real environment 90a, 90b depicted in FIGS. 1A and 1B, respectively, each include one respective user 100a and 100b, one or both of the real environments 90a, 90b may be modified to include more than one user without departing from the scope of the disclosure. While FIG. 2 depicts three users 100a, 100b, or 100c in the coordinated SR environment 200 of FIG. 2, the coordinated SR environment 200 may be modified to include more or fewer than three users without departing from the scope of the disclosure. In addition, the particular real environments 90a, 90b depicted in FIGS. 1A and 1B, respectively, and the coordinated SR environment 200 depicted in FIG. 2 are exemplary, and it is understood that the SR system or platform may be adapted to be used with many other types of real world environments and may implement many other types of SR environments.

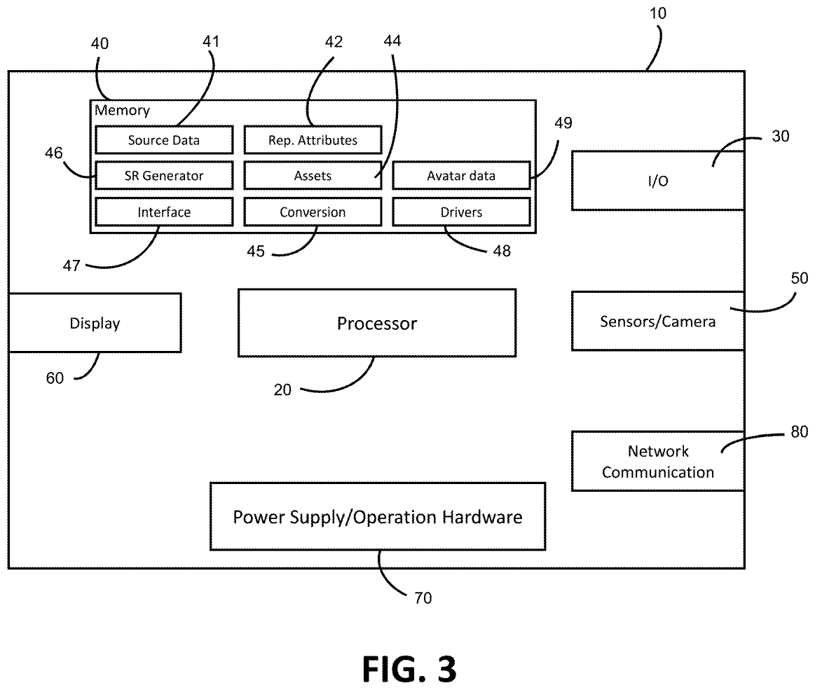

FIG. 3 illustrates a block diagram of a computing device 10 for implementing a coordinated simulated realty environment according to various embodiments described herein. The computing device 10 may be configured to provide a shared representation of data and/or for implementing an SR environment, such as the coordinated SR environment 200 of FIG. 2. The representative data may be combined by the SR system (or SR platform) to form one or more assets. The computing device 10 may support and implement a portion of the SR platforms or SR systems illustrated in the other figures shown and discussed herein and/or may support and implement all of the SR platforms or SR systems illustrated in the other figures shown and discussed herein. For example, computing device 10 may be a part of a single device or may be segregated into multiple devices that are networked or standalone. In some examples, the SR systems or SR platforms illustrated in the other figures shown and discussed herein may implement more than one of the computing devices 10 of FIG. 3, in whole or in part. The computing device 10 need not include all of the components shown in FIG. 3 and described below. In various embodiments, the computing device 10 may include interfaces, displays, cameras, sensors, or any combination thereof. In various examples, the computing device 10 may exclude one or more of an interface, a display, a camera, or a sensor. As used herein, the SR platform may include the computing device 10, in some examples. In other examples, the SR platform may include more than one of the computing devices 10, in whole or in part.

In accordance with various embodiments, as illustrated in FIG. 3, the computing device 10 includes one or more processing elements 20, input/output (I/O) interfaces 30, one or more memories 40, a camera and/or sensors 50, a display 60, a power source 70, one or more networking/communication interfaces 80, and/or other suitable equipment for implantation of an SR platform, with each component variously in communication with each other via one or more systems busses or via wireless transmission means. Each of the components will be discussed in turn below.

As indicated above, the computing device 10 includes one or more processing elements 20. The one or more processing elements 20 refers to one or more devices within the computing device 10 that is configurable to perform computations via machine-readable instructions stored within the one or more memories 40 of the computing device 10. The one or more processing elements 20 may include one or more microprocessors (CPUs), one or more graphics processing units (GPUs), one or more digital signal processors (DSPs), or any combination thereof. In addition, the one or more processing elements 20 may include any of a variety of application specific circuitry developed to accelerate the computing device 10. The one or more processing elements 20 may include substantially any electronic device capable of processing, receiving, and/or transmitting instructions. For example, the one or more processing elements 20 may include a microprocessor or a microcomputer. Additionally, it should be noted that the one or more processing elements 20 may include more than one processing member. For example, a first processing element may control a first set of components of the computing device 10 and a second processing element may control a second set of components of the computing device 10, where the first and second processing elements may or may not be in communication with each other. For example, the one or more processing elements 20 may include a graphics processor and a central processing unit that are used to execute instructions in parallel and/or sequentially.

In accordance with various embodiments, one or more memories 40 are configured to store software suitable to operate the computing device 10. Specifically, the software stored in the one or more memories 40 launches the coordinated SR environments via an SR generator 46 within the computing device 10. The SR generator 46 may be configured to render SR environments suitable to be communication to a display. To render the coordinated SR environment, the SR generator 46 may pull the assets from asset memory 44 and instantiate the pulled assets in a suitably related environment provided by the SR generator 46. The one or more processor elements 20 may render the asset and/or one or more of user representations (e.g., avatars) in respective displays based on relative positions between the asset and the one or more users or user representations (e.g., avatars). In some examples, the one or more processor elements 20 may assign respective locations to one or more of the asset and/or the user representations (e.g., avatars) within the simulated reality, such as based on user input. In some examples, the one or more processor elements 20 may determine respective locations of one or more of the asset and/or one or more of the user representations (e.g., avatars) based on real world environment data within the simulated reality, such as based on user input. The assets may be stored in the asset memory 44 after the conversion engine 45 converts the source data 41 to representative attributes 42. Information from the representative attributes 42 may be combined with the assets to form the assets that are stored in the asset memory 44. The one or more processor elements 20 may be configured to access the assets stored in the asset memory 20. The source data 41 may locally be stored in a database, file, or suitable format, or it may be stored remotely. The conversion engine 45 combs each of the records within the source data 41 for entries and applies a conversion function suitable to convert each of the entries in the record to a corresponding representative attribute 42. The conversion function modifies the default value of the representative attribute type assigned to each field of the record. This forms a table of representative attributes 42 that are assigned to an asset for each record forming the asset stored in the asset memory 44.

Each of the source data memory 41, the representative attributes memory 42, the asset memory 44, and the conversion functions within the conversion engine 45 may be dynamically updated via the interface memory 47. In various embodiments, the one or more processing elements 20 may access the SR generator 46 and the interface memory 47 to instantiate a user interface within the coordinated SR environment, allowing a user access to review or modify the source data memory 41, the representative attributes memory 42, the asset memory 44, and the conversion functions within the conversion engine 45. Specifically, modification of the conversion functions within the conversion engine 45 allows source attributes to be mapped to representative attributes differently, such that the SR generator 46 and the one or more processing elements 20 render a modified SR environment in response to the user modifications.

The SR generator 46 configured to provide instructions to the one or more processing elements 20 in order to display images to the proper display in the proper format such that the image is presented in 3D or as a 3D simulation. Thus, if the display 60 is a screen, the display is in a 3D simulation. If the display 60 is a hologram projector, the display is in actual 3D. If the display 60 is a VR headset, the display 60 can be provided in stereo allowing the display headset to provide a 3D simulation. The SR generator 46 may also access information from the avatar data 49 in order to locate the user's avatar in the coordinated SR environment and/or other avatars in the coordinated SR environment with the user's avatar. The avatar data 49 may receive communications from the camera and/or sensors 50, the networking/communication interface 80, or the I/O interface 30 for information, characteristics, and various attributes about the user, the user's position, actions, etc., in order to provide the SR system or platform with sufficient information to form, manipulate, and render the user's avatar within the coordinated SR environment. The same may apply for the avatar of other users.

In accordance with various embodiments, the computing device 10 may include one or more networking/communication interfaces 80. The one or more networking/communication interfaces 80 may be configured to communicate with other remote systems. The one or more networking/communication interfaces 80 may receive data at and transmit data from the computing device 10. The one or more networking/communication interfaces 80 may provide (e.g., transmit, send, etc.) data to a network, other computing devices, etc., or combinations thereof. For example, the one or more networking/communication interfaces 80 may provide data to and receive data from other computing devices through the network. In particular, the network may be substantially any type of communication pathway between two or more computing devices. The network may include a wireless network (e.g., Wi-Fi, Bluetooth, cellular network, etc.) a wired network (Ethernet), or a combination thereof. In some embodiments, the one or more networking/communication interfaces 80 may be used to access various aspects of the SR platform from the cloud, other devices, or dedicated servers.

In various embodiments, the one or more networking/communication interfaces 80 may also receive communications from one or more of the other systems including the I/O interfaces 30, the one or more memories 40, the camera and/or sensors 50, and/or the display 60. In a number of embodiments, the computing device 10 may use driver memory 48 to operate the various peripheral devices, including the display 60, devices connected via the I/O interfaces 30, the camera and/or sensors 50, and/or the power source 70, and/or the one or more networking/communication interfaces 80.

In accordance with various embodiments, the SR system or platform provides the user ability to load data from existing tools into the virtual space, world, or landscape. For example, an I/O interfaces 30 allows the computing device 10 to receive inputs from a user and provide output to the user. For example, the I/O interfaces 30 may include a capacitive touch screen, keyboard, mouse, camera, stylus, or the like. The type of devices that interact via the I/O interfaces 30 may be varied as desired. Additionally, the I/O interfaces 30 may be varied based on the type of computing device 10 used. Other computing devices may include similar sensors and other I/O devices.

The one or more memories 40 may be configured to store electronic data that may be utilized by the computing device 10. For example, the one or more memories 40 may store electrical data or content, such as audio files, video files, document files, and so on, corresponding to various applications. The one or more memories 40 may include, for example, non-volatile storage, a magnetic storage medium, an optical storage medium, a magneto-optical storage medium, read-only memory, random-access memory, erasable-programmable memory, flash memory, or a combination of one or more types of memory.

The display 60 may be separate from or integrated with the computing device 10. For example, for cases in which the computing device 10 includes a smart phone or tablet computer, the display 60 may be integrated with the computing device 10 and in instances where the computing device 10 includes a server or a desktop computer, the display 60 may be separate from the computing device 10. In some embodiments, such as when the display 60 includes a VR headpiece, AR goggles, or the like, the display 60 may be separate from the computing device 10, even when the computing device 10 includes a smart phone or tablet computer. The display 60 provides a visual output for the computing device 10 and may output one or more graphical user interfaces (GUIs).

In accordance with various embodiments, the user can move around the virtual space in any direction desired to be enabled. The SR generator 46 may receive information from the I/O interfaces 30, the camera and/or sensors 50, the one or more networking/communication interfaces 80, and/or the avatar data 49 so as to render the coordinated SR environment continuously from different perspectives as the user provides input through the I/O interfaces 30, camera and/or sensors 50, or the one or more networking/communication interfaces 80 to change the user's relative location in the coordinated SR environment. In accordance with various embodiments, multiple users can enter the coordinated SR environment and view the same graphics, along with transformations made by any user. Thus, the SR system provides the user the ability to be immersed in the data. In accordance with various examples, a user can view data from different perspectives in a three dimensional layout or world. In accordance with various embodiments, the coordinated SR environment provides the user the ability to interact with the data using hand/controller, movements, standard keyboard/mouse, or similar interactive devices via one or more communication ports such as the I/O interfaces 30, camera and/or sensors 50, or the one or more networking/communication interfaces 80. In one example, the user can use the I/O interfaces 30, camera and/or sensors 50, or the one or more networking/communication interfaces 80 to access the interface and make changes as discussed above. In various examples, the user can use the I/O interfaces 30, camera and/or sensors 50, or the one or more networking/communication interfaces 80 to approach an asset within the coordinated SR environment and interact with it to view, modify, or analyze source data, representative attribute types, conversion factors, or assets. In accordance with various embodiments, the interaction is configured to visually output statistical relationships between attributes while in the experience. For example, such outputs may include trend-line visualizations as well as regression equations and statistics, including, but not limited to, R-Squared, betas, standard errors, t stats, and p stats. This information can be viewed by approaching assets or groups of assets.

In accordance with one example, the computing device 10 may map source data into data representations, such as the data representations 150, 160 of the coordinated SR environment 200. The SR environment allows for the comparison, evaluation, analysis, and/or modification of multiple records.

In various examples, the user enters or retrieves data from a database or similar source (e.g., spreadsheet) into an application for use in the SR system or platform. The collection application may be stored in such a way as to allow access by the SR system or platform (e.g., the computing device 10). For example, the SR system or platform loads or generates a spreadsheet based on data obtained from the cloud to an SR system or platform location or more specifically the one or more memories 40 allocated therein, as discussed above. The SR system or platform may be configured to receive or access a user's data from the spreadsheet. The SR system or platform may allow the users to access or modify the data together while maintaining their respective viewpoints with respect to the data.

The SR system or platform enables the user to enter the coordinated SR environment and open, access, review, or analyze the 3D visualization by interacting with a controller (e.g., hand controller, gesture monitor on a headset, or any other suitable controller) to move about and manipulate the environment. Using SR system or platform, the user can immerse himself or herself in a coordinated setting with the other users, allowing them to better understand and/or manipulate the complex data relationships together. In accordance with various embodiments, each of the users may move around the virtual space in any direction and may enter the experience, regardless of the type of SR system or platform (e.g., whether in VR, AR, MR, or at a desktop), and view the same graphics, along with the modification and direct interactions made by any of the other users. Because of the live interaction and the ability to modify data and relationships, the entire environment may be modified on the fly. In some embodiments, some users may merely view the coordinated SR environment without being represented within the coordinated SR environment.

As discussed above, the coordinated SR environment allows an individual user to change their perspective, while enabling the other users to experience the change in location of that user. This changing of perspectives in the coordinated SR environment interface allow a user to fully explore and integrate into the world. Accordingly, the SR system or platform provides the user with the ability to move around the coordinated SR environment and interact with the data while simultaneously experiencing the other users doing the same within a common framework. Additionally, users can share or show the coordinated SR environment to other people who have also entered the coordinated SR environment via a VR headset. Additionally, the SR system is configured for allowing the ability to scale the data representation relative to the viewer's virtual or perspective size.

The power source 70 provides power to the various components of the computing device 10. The power source 70 may include one or more rechargeable, disposable, or hardwire sources, e.g., batteries, power cord, or the like. Additionally, the power source 70 may include one or more types of connectors or components that provide different types of power to the computing device 10. The types and numbers of power sources 70 may be varied based on the type of computing devices 10.

The sensors of the camera and/or sensors 50 may provide substantially any type of input to the computing device 10. For example, the sensors may be one or more accelerometers, microphones, global positioning sensors, gyroscopes, light sensors, image sensors (such as cameras), force sensors, and so on. The type, number, and location of the sensors may be varied as desired and may depend on the desired functions of the SR system or platform.

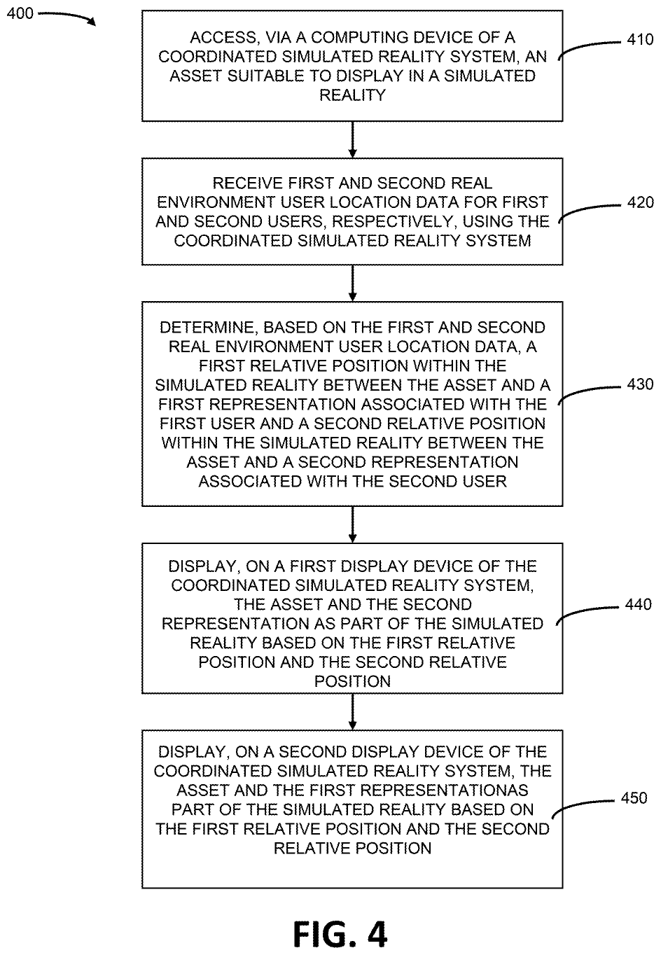

FIG. 4 includes an exemplary flowchart of a method 400 to provide a coordinated simulated realty SR environment according to various embodiments described herein. The method 400 may be performed by the SR system or platform described with reference to FIGS. 1A, 1B, 2, and/or 3, and/or may be performed by one or more of the computing devices 10 of FIG. 3. For example, the method 400 may be performed by one or more processor elements (e.g., the one or more processing elements 20 of FIG. 3) by executing instructions stored in one or more memories (e.g., the one or more memories 40 of FIG. 3). The method may be configured to provide the coordinated SR environment 200 of FIG. 2, in some examples.

The method 400 may include accessing, via a computing device of a coordinated simulated reality system, an asset suitable to display in a simulated reality, at 410. The computing device may be included in the SR platform or system, and/or may include at least part of the computing device 10 of FIG. 3. The asset may include one or more of the users 100a, 100b, and 100c, and/or the shared presentation data 150, 160, 180 of FIGS. 1A, 1B, and/or 2, and/or assets stored in the asset memory 44 of FIG. 3.

The method 400 may further include receiving first and second real environment user location data for first and second users, respectively, using the coordinated simulated reality system, at 420. The first and second real environment location data may be received from one or more input devices, such as one or more of the cameras 132a, 132b, 142, 170a, or 170b of FIGS. 1A, 1B, and/or 2, or the camera and/or sensors 50 of FIG. 3. In some examples, the method 400 may further include receiving the first and second real environment user location data based on information from a real environment anchor. In some examples, the method 400 may further include determining a location of the asset based on the information from the real environment anchor. In some examples, the method 400 may further include receiving the first and second real environment user location data based on information from first and second real environment anchors, respectively. In some examples, the real environment anchor and/or the first and second real environment anchors include tangible objects suitable to be picked up by an input device. The real environment anchor and/or the first and second real environment anchors may include one or more real environment anchors 110a, 110b, 110c of FIGS. 1A, 1B, and/or 2.

The method 400 may further include determining, based on the first and second real environment user location data, a first relative position within the simulated reality between the asset and a first representation associated with the first user and a second relative position within the simulated reality between the asset and a second representation associated with the second user, at 430. The first and second representations may include the users 100a, 100b, and/or 100c or avatars 131a, 131b, 131c of FIGS. 1A, 1B, and/or 2, and/or may be based on the avatars data 40 of FIG. 3. Other user representations and/or avatar formats may be implemented without departing from the scope of the disclosure.

The method 400 may further include displaying, on a first display device of the coordinated simulated reality system, the asset and the second representation as part of the simulated reality based on the first relative position and the second relative position, at 440. The method 400 may further include displaying, on a second display device of the coordinated simulated reality system, the asset and the first representation as part of the simulated reality based on the first relative position and the second relative position, at 450. In some examples, the method 400 may further include displaying, on a second display device of the coordinated simulated reality system, the asset, the first representation, and the second representation as part of the simulated reality based on the first relative position, the second relative position, and the third relative position. In some examples, at least one of the asset, the first representation, or the second representation is displayed on the second display device from a different perspective than displayed on the display device. The display device and the second display device may include any of the display devices 102, 130a-c, 140 of FIGS. 1A, 1B, and/or 2, and/or the display 60 of FIG. 3. In some examples, the method 400 may include assigning a first location to the first user within the simulated reality and a second location to the second user within the simulated reality. In other examples, the method 400 may include determining a first location of the first user within the simulated reality based on the first real world environment data and a second location of the second user within the simulated reality based on the second real world environment data. The second representation may be displayed at a location in the first display device based on the second location and the first representation may be displayed at a location in the second display device based on the first location and the second location. That is, the perspective and location of each of the first and second representations (e.g., avatars) within the simulated reality may be determined based on real world location data, may be assigned based on other information, such as user input, or any combination thereof.

In some examples, the method 400 may further include receiving information from a real environment input device, and rendering a real environment in the display on the display device along with the asset based on the information received the real environment input device. The real environment input device may include one or more of the cameras 132a, 132b, 142, 170a, or 170b of FIGS. 1A, 1B, and/or 2, or the camera and/or sensors 50 of FIG. 3. The real environment may include the real environments 90a or 90b of FIGS. 1A and 1B, respectively, the coordinated SR environment 200 of FIG. 2, or combinations thereof.

In some examples, the method 400 may further include tracking a spatial relationship between the first and second users, and updating display of the first representation or the second representation on the display device based on a change of the spatial relationship between the first and second users. The tracking may be based on inputs received via one or more of the cameras 132a, 132b, 142, 170a, or 170b of FIGS. 1A, 1B, and/or 2, or the camera and/or sensors 50 of FIG. 3. In some examples, the method 400 may further include updating display of at least one of the asset, the first representation, or the second representation based on a received user input requesting a change to the simulated reality. The input may be received via one or more of more of the cameras 132a, 132b, 142, 170a, or 170b of FIGS. 1A, 1B, and/or 2, and/or one or more of the I/O interfaces 30, camera and/or sensors 50, or the one or more networking/communication interfaces 80 of FIG. 3.

The term “about,” as used herein, should generally be understood to refer to both the corresponding number and a range of numbers. Moreover, all numerical ranges herein should be understood to include each whole integer within the range. While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

What is claimed is:

1. A coordinated simulated reality system, comprising:
first and second display devices associated with first and second users, respectively;
a non-transitory memory containing computer-readable instructions operable to create a simulated reality; and
a processor configured to execute the instructions to:
access an asset suitable to display in the simulated reality;
receive first and second real environment user location data for the first and second users, respectively;
determine a first relative position between the asset and a first representation of the first user in the simulated reality and a second relative position between the asset and a second representation of the second user in the simulated reality first and second real environment user location data;
cause first respective renderings of the asset and the second representation to be provided in a first display on the first display device as part of the simulated reality based on the first and second relative positions; and
cause second respective renderings of the asset and the first representation to be to be provided in a second display on the second display device as part of the simulated reality based on the first and second relative positions.

2. The coordinated simulated reality system of claim 1, wherein the simulated reality includes an augmented reality platform for the first user, and wherein the processor is further configured to execute the instructions to:
receive information from a real environment input device; and
cause a real environment to be rendered in the first and second displays on the first and second display devices along with the asset based on the information received from the real environment input device.

3. The coordinated simulated reality system of claim 1, further comprising a real environment anchor, wherein the real environment user location data is based, at least in part, on information from the real environment anchors.

4. The coordinated simulated reality system of claim 3, wherein the first user is associated with the real environment anchor.

5. The coordinated simulated reality system of claim 4, wherein the second user is associated with a second real environment anchor.

6. The coordinated simulated reality system of claim 1, wherein the processor is further configured to execute the instructions to:
assign a first location to the first user within the simulated reality and a second location to the second user within the simulated reality; and
cause the first representation to be rendered at a location in the second display based on the first and second locations and cause the second representation to be rendered at a location in the first display based on the first and second locations.

7. The coordinated simulated reality system of claim 1, wherein the processor is further configured to execute the instructions to:
determine a first location of the first user within the simulated reality based on the first real world environment data and a second location of the second user within the simulated reality based on the second real world environment data; and
cause the first representation to be rendered at a location in the second display based on the first and second locations and the second representation to be rendered at a location in the first display based on the first and second locations.

8. The coordinated simulated reality system of claim 1, wherein the processor is further configured to execute the instructions to cause respective renderings of the asset on a surface within the first and second displays.

9. The coordinated simulated reality system of claim 1, wherein the processor is further configured to execute the instructions to:
track a spatial relationship the first and second users; and
cause a location of the second user to be updated in the first display and a location of the first user to be updated in the second display based on a change in the spatial relationship the first and second users.

10. The coordinated simulated reality system of claim 1, wherein the asset is viewed from a first perspective on the first display by the first user and is viewed from a second perspective that is different than the first perspective on the second display by the second user.

11. The coordinated simulated reality system of claim 1, further comprising an input device configured to receive information in response to input from the first user, wherein the processor is further configured to execute the instructions to implement a change to the simulated reality based on information received from the input device, wherein the change to the simulated reality includes a modification of the asset, an interaction with the second user, or a modification of a viewpoint of one the first or second users in the simulated reality.

12. A method, comprising:
accessing, via a computing device of a coordinated simulated reality system, an asset suitable to display in a simulated reality;
receiving first and second real environment user location data for first and second users, respectively, using the coordinated simulated reality system;
determining, based on the first and second real environment user location data, a first relative position within the simulated reality between the asset and a first representation associated with the first user and a second relative position within the simulated reality between the asset and a second representation associated with the second user;
displaying, on a first display device of the coordinated simulated reality system, the asset and the second representation as part of the simulated reality based on the first relative position and the second relative position; and
displaying, on a second display device of the coordinated simulated reality system, the asset and the first representation as part of the simulated reality based on the first relative position and the second relative position.

13. The method of claim 12, further comprising:
receiving information from a real environment input device; and
rendering a real environment in the display on the display device along with the asset based on the information received the real environment input device.

14. The method of claim 12, further comprising receiving the first and second real environment user location data based on information from a real environment anchor.

15. The method of claim 12, further comprising:
assigning a first location to the first user within the simulated reality and a second location to the second user within the simulated reality based on user input, wherein the second representation is displayed at a location in the first display device based on the second location and the first representation is displayed at a location in the second display device based on the first location and the second location.

16. The method of claim 12, further comprising:
determining a first location of the first user within the simulated reality based on the first real world environment data and a second location of the second user within the simulated reality based on the second real world environment data, wherein the second representation is displayed at a location in the first display device based on the second location and the first representation is displayed at a location in the second display device based on the first location and the second location.

17. The method of claim 13, further comprising displaying, on a second display device of the coordinated simulated reality system, the asset, the first representation, and the second representation as part of the simulated reality based on the first relative position, the second relative position, and the third relative position.

18. The method of claim 17, wherein at least one of the asset, the first representation, or the second representation is displayed on the second display device from a different perspective than displayed on the display device.

19. The method of claim 12, further comprising:
tracking a spatial relationship between the first and second users; and
updating display of the first representation or the second representation on the display device based on a change of the spatial relationship between the first and second users.

20. The method of claim 12, further comprising updating display of at least one of the asset, the first representation, or the second representation based on a received user input requesting a change to the simulated reality.
